(19) United States
(12) Patent Application Publication
(10) Pub. No.: US 2012/0311928 A1
(43) Pub. Date: Dec. 13, 2012

(54) CONTAINER FOR GROWING PLANT

(75) Inventors: WANG-PING KO, Taoyuan County (TW); Shiue-Chiau Liu, Taoyuan County (TW); Kuei-Jen Chang, Taoyuan County (TW)

(73) Assignee: HAIR O'RIGHT INTERNATIONAL CORPORATION, Taoyuan County (TW)

(21) Appl. No.: 13/158,902

(22) Filed: Jun. 13, 2011

(51) Int. Cl. A01G 9/02

(52) U.S. Cl. 47/65.7

(57) ABSTRACT

A container for growing plant includes a main body, a seed coating and at least a seed. The main body is composed of a biodegradable plastic material and has a seed portion. The seed coating is composed of the biodegradable plastic material and is disposed in the seed portion. The at least a seed is sealed in the seed portion of the main body through the seed coating. After a user uses up a content in the container for growing plant, the waste container can be buried into the soil to be biodegraded by the microorganism in the soil so that the seed inside the container is contacted with the air, the water and the soil to germinates, thereby growing the valuable plant.

### FIELD OF THE INVENTION

The present invention relates to a container for growing plant, and more particularly to a container containing a seed, which can be buried into the soil to be decomposed by the microorganism so that the seed is contacted with the soil, the air and the water to germinate and grow.

### BACKGROUND OF THE INVENTION

Typically, containers such as bottles are made of a non-biodegradable plastic material, for example, polyethylene (PE), polyethylene terephthalate (PET), polypropylene (PP). The non-biodegradable plastic containers can not be treated by a landfill method, because such non-biodegradable plastic materials can not be decomposed by the microorganism after a hundred years. Additionally, if the non-biodegradable plastic containers are treated by a thermal decomposition method, decomposition products including various toxic substances are generated, thereby affecting environmental protection. Therefore, currently, the non-biodegradable plastic containers is generally be treated by a recycling method. However, it is undesirable to implement the recycling method. Because it is more difficulty to collect the non-biodegradable plastic containers than to collect the metal, the non-biodegradable plastic containers can not be collected and put back effectively. Further, the collected plastic containers can not be classified automatically to select the non-biodegradable plastic containers, thereby increasing the labour cost of classifying the non-biodegradable plastic containers artificially. Moreover, some of the plastic containers are made of multiple non-biodegradable plastic materials. If the multiple non-biodegradable plastic materials are separated to be recycled to get a recycling product, the cost of separating the multiple non-biodegradable plastic materials is more expensive than the price of the recycling product. Thus, for example, the coefficient of recovery of the non-biodegradable plastic containers in America is only 5%.

Comparative to the non-biodegradable plastic materials, biodegradable plastic materials mainly composed of poly lactic acid (PLA) are called green plastics. When the biodegradable plastic materials are in a natural burial condition or a composting condition having suitable humidity, oxygen and microorganism, the biodegradable plastic materials can be metabolized by the microorganism to be decomposed, thereby generating degradation products such as water and carbon oxide, or methane. The degradation products are friendlier to the environmental than the decomposition products by other methods. However, it is not easy for a common user to distinguish the biodegradable plastic containers. Thus, the biodegradable plastic containers can not be collected and put back yet. In addition, the common user usually drops the waste biodegradable plastic containers in a collection box to be mixed with the non-biodegradable plastic containers, thereby causing a classifying problem.

Therefore, what is needed is to provide a container for growing plant, which can be distinguished from the general containers so as to overcome the above mentioned disadvantages. After a user uses the container for growing plant, the container for growing plant can be buried into the soil in a garden or in a garden pot to be decomposed so that a seed inside the container germinates and grows.

### SUMMARY OF THE INVENTION

Therefore, the present invention provides a container for growing plant, which can be distinguished from the general containers by a common user and can be buried into the soil to be decomposed, thereby growing the valuable plant and reducing the difficulty of classifying and the collection cost.

The present invention provides a container for growing plant includes a main body, a seed coating and at least a seed. The main body is composed of a biodegradable plastic material and has a seed portion. The seed coating is composed of the biodegradable plastic material and is disposed in the seed portion. The at least a seed is sealed in the seed portion of the main body through the seed coating.

In one embodiment of the present invention, the seed portion is a concave hole.

In one embodiment of the present invention, the seed coating is inserted into the concave hole.

In one embodiment of the present invention, the seed portion is located at a side of the main body.

In one embodiment of the present invention, the seed portion is located at a bottom of the main body.

In one embodiment of the present invention, the at least a seed is coated by and located inside the seed coating.

In one embodiment of the present invention, the biodegradable plastic material includes poly lactic acid.

The present invention also provides a container for growing plant includes a main body, a base, a seed coating and at least a seed. The main body is composed of a biodegradable plastic material. The base is composed of the biodegradable plastic material and is assembled with a bottom of the main body. The base has a seed portion at a bottom thereof. The seed coating is composed of the biodegradable plastic material and is disposed in the seed portion. The at least a seed is sealed in the seed portion of the base through the seed coating.

In the present invention, the container for growing plant can be effectively distinguished from the general containers, thereby avoiding dropping the container for growing plant into the collection box to be mixed with the general containers and reducing the difficulty of classifying and the collection cost. In addition, after the user uses the container for growing plant, the waste container for growing plant can be buried into the soil in a garden or in a garden pot to be decomposed so that a seed inside the container germinates, thereby growing the valuable plant.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates a schematic, exploded view of a container for growing plant in accordance with an embodiment of the present invention.

FIG. 2 illustrates a schematic, assembled view of the container for growing plant shown in FIG. 1.

FIG. 3 illustrates a schematic, cross-sectional view of the container for growing plant shown in FIG. 2 along the line A-A.

FIG. 4 illustrates a schematic, cross-sectional view of a container for growing plant in accordance with another embodiment of the present invention.

FIG. 5 illustrates a schematic, exploded view of a container for growing plant in accordance with still another embodiment of the present invention.

FIG. 6 illustrates a schematic, assembled view of the container for growing plant shown in FIG. 5.

FIG. 7 illustrates a schematic view of the container for growing plant shown in FIG. 1, which is buried into the soil.

FIG. 8 illustrates a schematic view of a seed in the container for growing plant shown in FIG. 1, which grows a plant.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

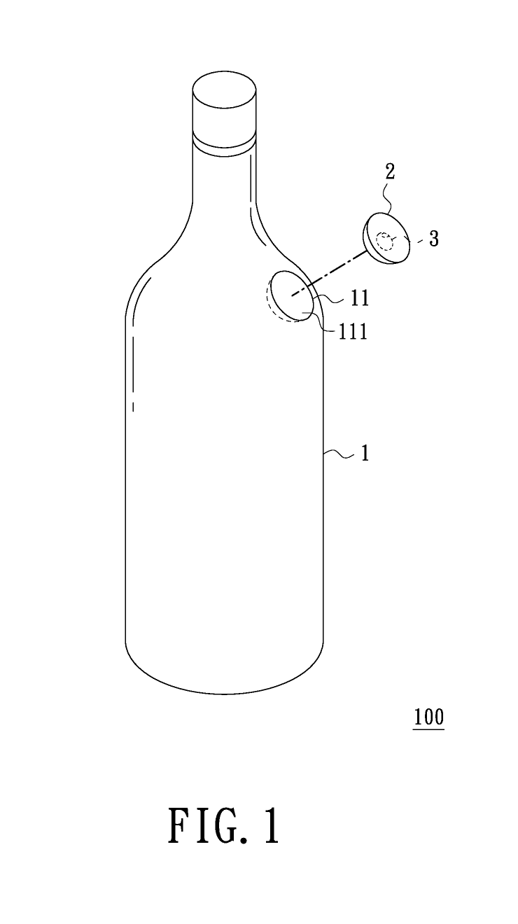

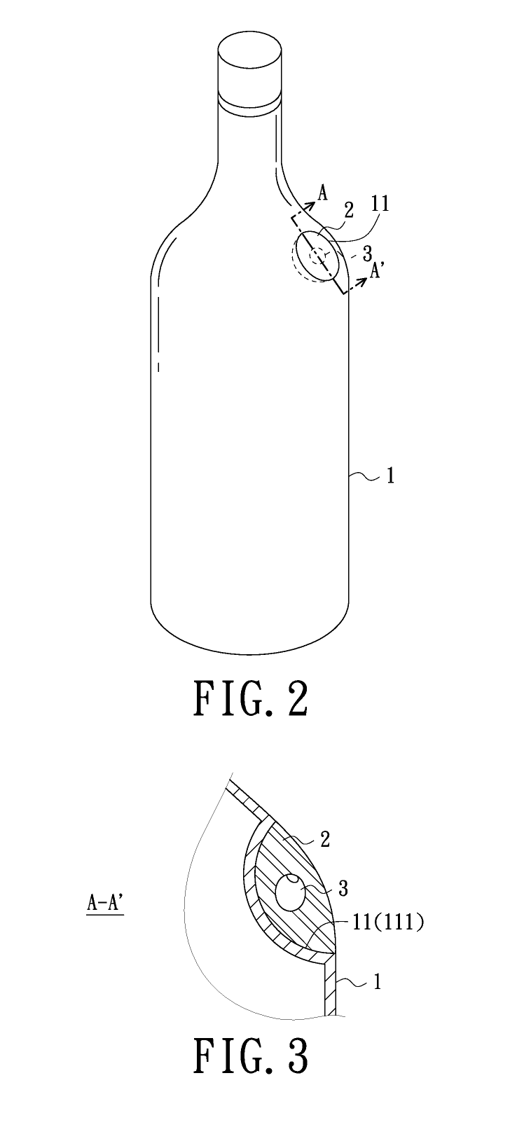

Referring to FIG. 1, FIG. 2 and FIG. 3, in the present embodiment, a container for growing plant 100 is, but not limited to, a bottle. The container for growing plant 100 includes a main body 1, a seed coating 2 and at least a seed 3. The main body 1 is made of a biodegradable plastic material. The main body 1 has a seed portion 11 defined on a surface thereof. The seed coating 2 is also made of a biodegradable plastic material. The at least a seed 3 is coated by and located inside the seed coating 2. The at least a seed 3 can be, for example, a follower seed, a vegetable seed or a tree seed. The seed coating 2 and the at least a seed 3 are disposed in the seed portion 11 of the main body 1. In other words, the at least a seed 3 is sealed in the seed portion 11 of the main body 1 through the seed coating 2. Thus, after the main body 1 and the seed coating 2 are buried in the soil to be decomposed, the at least a seed 3 is released into the soil to germinate and grow.

In the present embodiment, the biodegradable plastic material can be, but not limited to, poly lactic acid (PLA). Further, in the present embodiment, the seed portion 11 of the main body 1 is a concave hole 111 defined in the main body 1. The seed coating 2 coating the at least a seed 3 is inserted into the concave hole 111 to be fixed. Thus, the at least a seed 3 is sealed in the seed portion 11 of the main body 1 through the seed coating 2. In the present embodiment, the concave hole 111 is located at a side of the main body 1.

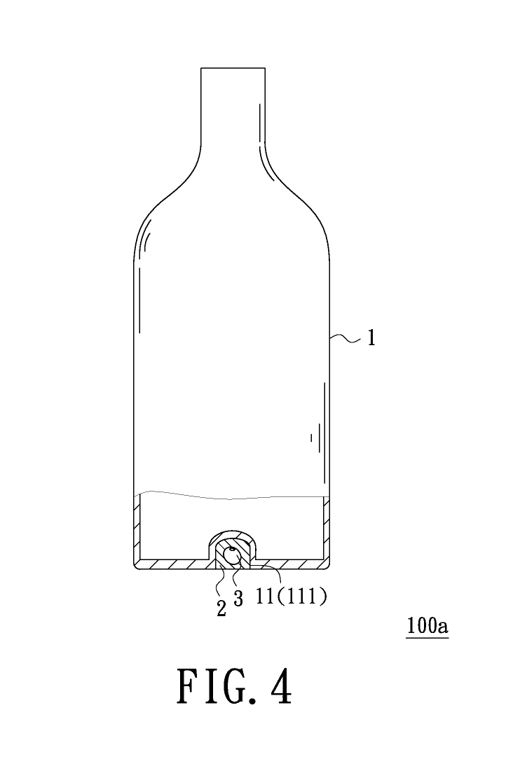

Referring to FIG. 4, in another embodiment, a container for growing plant 100a is similar to the container for growing plant 100 except that the concave hole 111 is located at a bottom of the main body 1.

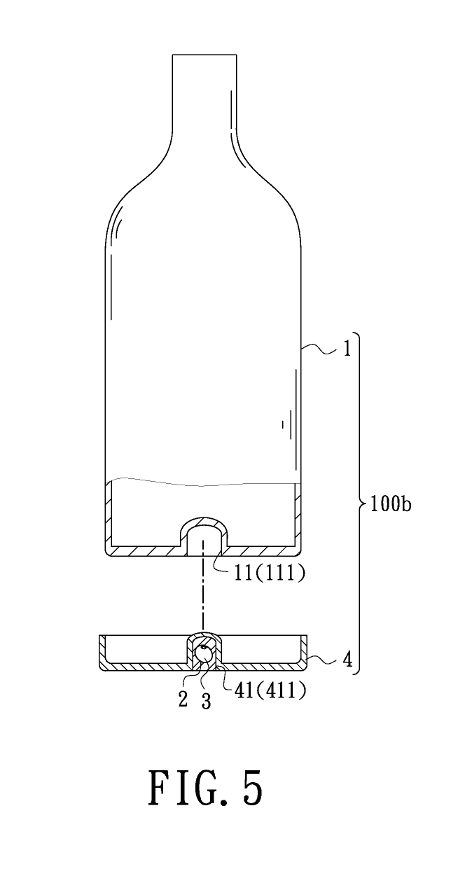

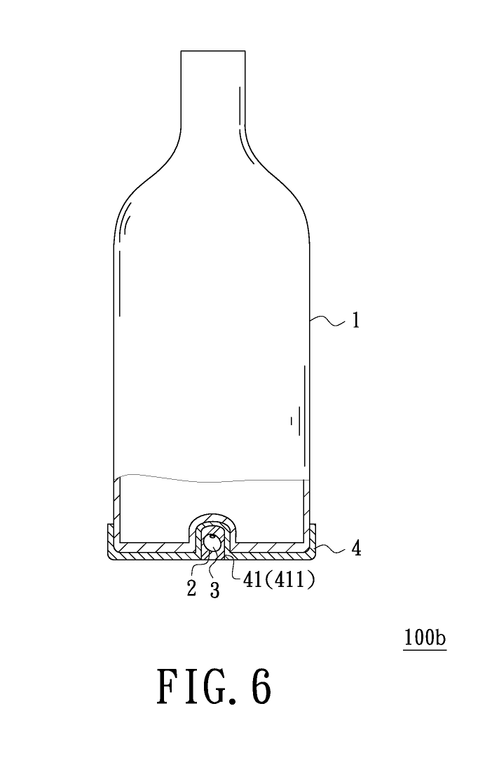

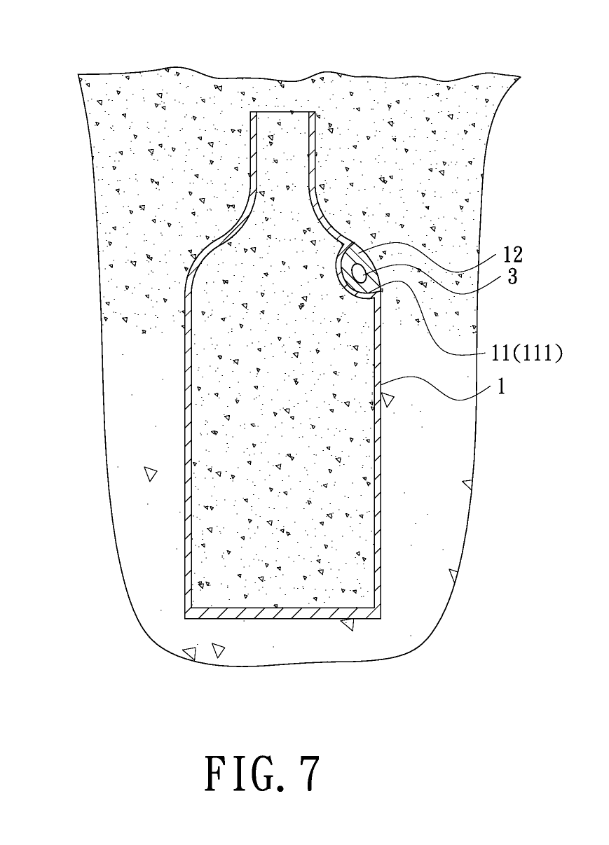

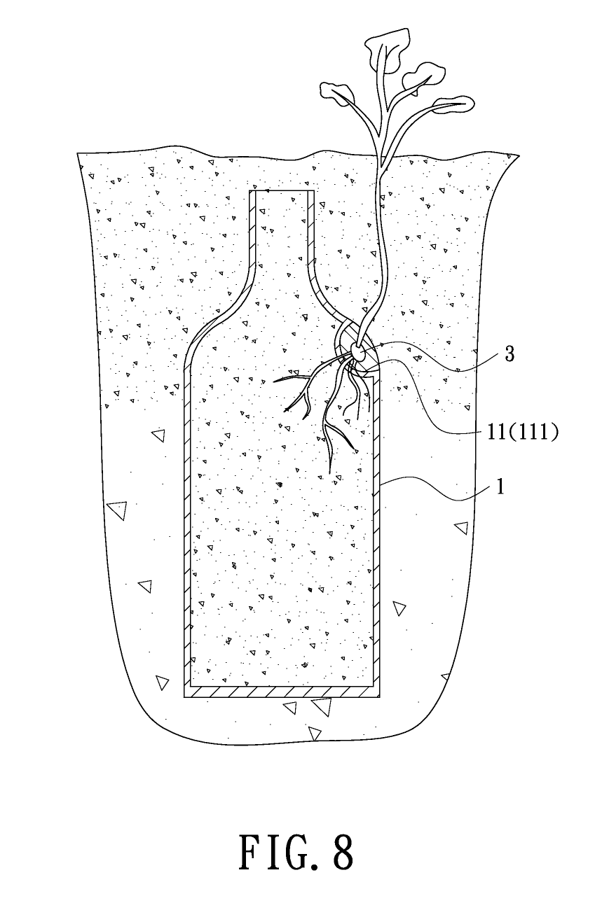

Referring to FIG. 5 and FIG. 6, in another embodiment, a container for growing plant 100b is similar to the container for growing plant 100a except that the container for growing plant 100b further includes a base 4 assembled with the bottom of the main body 1. The base 2 is also made of a biodegradable plastic material such as poly lactic acid (PLA). The base 4 has a seed portion 41 defined on a bottom thereof. In the present embodiment, the seed portion 41 of the base 4 is a concave hole 411 defined in the base 4. The seed coating 2 coating the at least a seed 3 can be inserted into the concave hole 411 to be fixed. In other words, the at least a seed 3 is sealed in the seed portion 41 of the base 4 through the seed coating 2. Thereafter, the base 4 is assembled with the main body 1.

As above mentioned, at first, the at the at least a seed 3 is coated by the seed coating 2, and then the seed coating 2 coating the at least a seed 3 is inserted into the concave hole 411 to be fixed. It is noted that, in other embodiments, the at the at least a seed 3 can be firstly disposed in the seed portion 11 or the seed portion 41, and then the seed coating 2 is filled into the seed portion 11 or the seed portion 41 to coat the at least a seed 3. It is also noted that, the at least a seed 3 should be hermetically seal and water tightly sealed to prevent the at least a seed 3 from the air and the humidity. Thus, after the main body 1, the seed coating 2, and even the base 4 buried in the soil are decomposed, the at least a seed 3 is released into the soil to germinate and grow.

In other embodiments, the container for growing plant can further include a label (not shown) disposed on the main body 1. The label can mark what is the at least a seed 3. Thus, after a content (e.g., beverage, shampoo, shower cream, and so on) in the container for growing plant is used up, a user can bury the waste container for growing plant into the soil in a garden or in a garden pot. After 12˜24 months, the main body 1, the seed coating 2, and even the base 4 buried in the soil are biodegraded by the microorganism in the soil. As a result, the at least a seed 3 is released and is contacted with the air, the water and the soil to germinate and grow plant for example flower, vegetable and tree.

In summary, the container for growing plant of the present invention has at least the following advantages. The container for growing plant can be effectively distinguished from the general containers, thereby avoiding dropping the container for growing plant into the collection box to be mixed with the general containers and reducing the difficulty of classifying and the collection cost. In addition, after the common user uses up the content in the container for growing plant, the waste container for growing plant can be buried into the soil in a garden or in a garden pot to be biodegraded by the microorganism in the soil so that the seed inside the container germinates, thereby growing the valuable plant.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A container for growing plant, comprising:
a main body composed of a biodegradable plastic material, the main body having a seed portion;
a seed coating composed of the biodegradable plastic material, the seed coating being disposed in the seed portion; and
at least a seed sealed in the seed portion of the main body through the seed coating.

2. The container for growing plant of claim 1, wherein the seed portion is a concave hole.

3. The container for growing plant of claim 2, wherein the seed coating is inserted into the concave hole.

4. The container for growing plant of claim 1, wherein the seed portion is located at a side of the main body.

5. The container for growing plant of claim 1, wherein the seed portion is located at a bottom of the main body.

6. The container for growing plant of claim 1, wherein the at least a seed is coated by and located inside the seed coating.

7. The container for growing plant of claim 1, wherein the biodegradable plastic material comprises poly lactic acid.

8. The container for growing plant of claim 1, wherein the main body comprises a base composed of the biodegradable plastic material, the base is assembled with a bottom of the main body and the seed portion is located at a bottom of the base.

9. The container for growing plant of claim 8, wherein the seed portion is a concave hole.

10. The container for growing plant of claim 9, wherein the seed coating is inserted into the concave hole.

11. The container for growing plant of claim 8, wherein the at least a seed is coated by and located inside the seed coating.

12. The container for growing plant of claim 8, wherein the biodegradable plastic material comprises poly lactic acid.
